(19) United States
(12) Patent Application Publication
(10) Pub. No.: US 2024/0418944 A1
(43) Pub. Date: Dec. 19, 2024

(54) ACTIVELY ALIGNED AND REFLOWABLE PLUGGABLE-CONNECTOR FOR PHOTONIC INTEGRATED CIRCUITS

(71) Applicant: Cisco Technology, Inc., San Jose, CA (US)

(72) Inventors: Shawn X. WANG, Carlsbad, CA (US); Michael P. MACK, San Diego, CA (US)

(21) Appl. No.: 18/335,611

(22) Filed: Jun. 15, 2023

(51) Int. Cl. G02B 6/36; G02B 6/38

(52) U.S. Cl. CPC G02B 6/3696; G02B 6/3672; G02B 6/3883

(57) ABSTRACT

Embodiments herein describe attaching (or bonding) alignment parts to a photonic die so that these alignment parts can then be used to passively align a FAU to the photonic die. In one embodiment, the alignment part (or parts) is aligned to a photonic die using a mounting FAU. The mounting FAU (along with the mated alignment parts) can then be actively aligned to the photonic die. When aligned, the alignment parts can be bonded (e.g., using cured epoxy) to the photonic die. The mounting FAU can then be lifted off, leaving the alignment parts attached to the photonic die. Later, a final product FAU (which may have a different shape than the mounting FAU) can then be passively aligned to the photonic die using the previously mounted alignment part or parts.

### TECHNICAL FIELD

Embodiments presented in this disclosure generally relate to aligning and coupling fiber array units (FAUs) to photonic dies.

### BACKGROUND

Current FAU connections made to photonics dies are performed at the individual module level or at the printed circuit board assembly (PCBA) panel level via active-alignment process with sub-micron accuracy followed by permanent bonding using epoxy. With respect to alignment and attachment, FAUs with long fiber pigtails and/or high fiber count are unwieldy therefore difficult to handle and automate. Furthermore, the FAU alignment and attachment tools and processes become tightly coupled to product form factors, i.e., fiber lengths, optical connectors, etc. often requiring tool and process redesign with each different product.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a process flow for mounting alignment parts to photonic dies using a mounting FAU, according to one embodiment.

FIG. 2 illustrates different types of optical connectors with different FAUs, according to one embodiment.

FIG. 3 illustrates attaching an FAU to alignment parts that have previously been attached to a photonic die, according to one embodiment.

FIGS. 4A and 4B illustrate attaching an FAU to alignment parts that have previously been attached to a photonic die, according to one embodiment.

FIGS. 5A and 5B illustrate attaching an FAU to alignment parts that have previously been attached to a photonic die, according to one embodiment.

FIG. 6 illustrates an alignment part with a body that holds two pins, according to one embodiment.

FIG. 7 illustrates an alignment part with two apertures, according to one embodiment.

FIG. 8 illustrates a clamp for fastening a removable FAU to a photonic die, according to one embodiment.

FIG. 9 illustrates attaching an FAU to alignment parts disposed on an edge of a photonic die, according to one embodiment.

FIG. 10 is a flowchart for attaching alignment parts to a photonic die, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a method that includes retrieving an alignment part using a mounting fiber array units (FAU); performing active alignment to align fibers in the mounting FAU and the alignment part to a photonic die; after aligning the mounting FAU to the photonic die, attaching the alignment part to the photonic die; and after attaching the alignment part, separating the mounting FAU from the alignment part and the photonic die.

Another embodiment presenting in this disclosure is an optical system that includes a photonic die comprising waveguides, an alignment part that is bonded to a surface of the photonic die using an adhesive, and a FAU mated with the alignment part where the mating between the FAU and the alignment part aligns optical fibers in the FAU to the waveguides in the photonic die.

### Example Embodiments

Embodiments herein describe attaching (or bonding) alignment parts to a photonic die so that these alignment parts can then be used to passively align an FAU to the photonic die. As mentioned above, many different end users (referred to herein as customers) use different types of FAUs along with different configurations of optical cables. The embodiments herein propose mounting alignment parts to a photonic die that are compatible with different types of FAUs. Thus, the photonic dies with the alignment parts allow customers to attach different types of FAUs to the photonic die.

In one embodiment, an alignment part (or parts) is aligned to a photonic die using a mounting FAU. For example, the mounting FAU may include two apertures that mate with respective pins on the alignment parts. The mounting FAU (along with the mated alignment parts) can then be actively aligned to a grating coupler in the photonic die. When aligned, the alignment parts can be bonded (e.g., using cured epoxy) to the photonic die. The mounting FAU can then be lifted off, leaving the alignment parts attached to the photonic die. The mounting FAU can then be mated to another pair of alignment parts and the process can repeat to attach these alignment parts to the next-in-line photonic die.

The photonic dies with the attached alignment pins can then be provided to a customer who can attach their own type of FAU to the alignment pins. This alignment can be a passive alignment because the alignment parts align the customer's FAU to an optical interface (e.g., a grating coupler) in the photonic die. This means no special placement and alignment tools are needed in order to align the customer's FAU to the photonic die. This can be performed either by a customer (who purchases the photonic die from the manufacturer and then attaches their own FAU) or the manufacturer who attaches a customer selected FAU to the photonic die before shipping the system to the customer. This method effectively makes the active alignment and bonding tool agnostic to the various optical connector formats and fiber length specifications. Further, because only the alignment parts are attached to the photonic dies, it is amenable to automation at wafer or die scale using existing active alignment and bonding technology. As the heat sensitive part of the FAU is not installed until the final assembly of the optical module (e.g., an optical transceiver), the photonic dies with the attached alignment parts can withstand the surface mount technology (SMT) reflow process which reduces manufacturing constraints. By separating the fiber subassembly from the precision alignment of the FAU to the photonic die, the precision alignment is performed to the optical engine which makes downstream processes simpler and packaging more versatile. That is, FAUs of various lengths and connector types do not need to be pre-defined as part of the finished goods until the final customization step.

Additionally, in one embodiment, the FAUs can be replaceable, which is an especially desirable feature for applications in co-packaged optics (CPO) as a single fiber break could render an entire system defective and non-repairable. Moreover, there are numerous proposed solutions for photonic die connectors that involve intricate bridging components such as prisms, reflectors, lenses, waveguides, etc., for the light to reach from the fiber to the die. These extra components add to overall complexity and therefore increased cost. Performance wise, the extra optical coupling interfaces increase insertion loss, and the short waveguides/fiber stubs can introduce multipath interference (MPI). The embodiments herein can omit these components by allowing direct optical fiber connection to the photonics die.

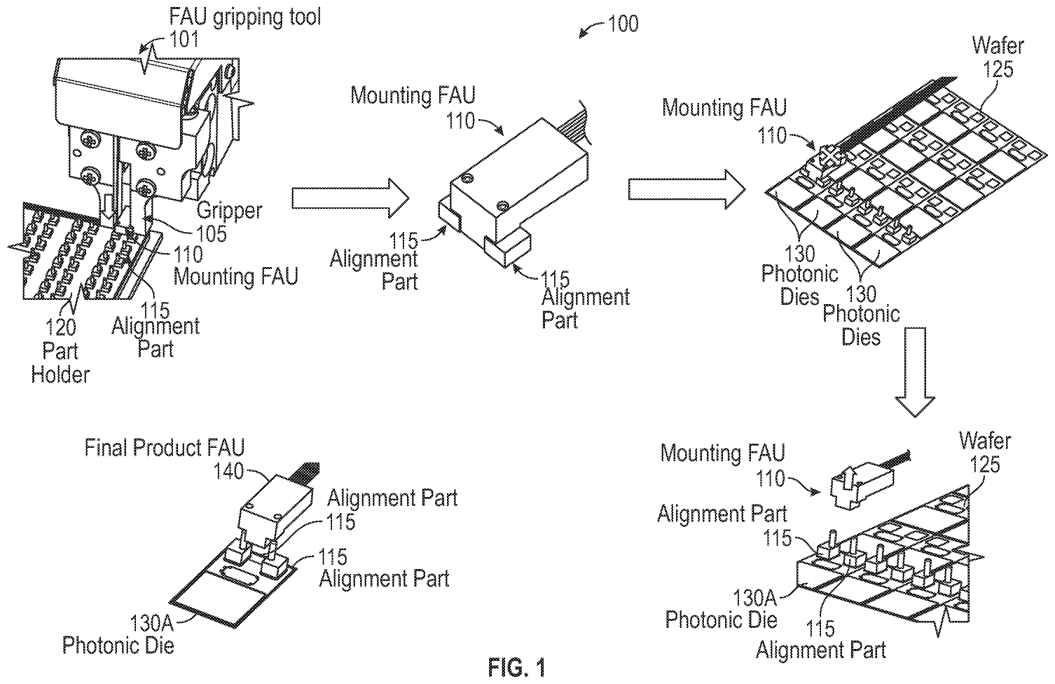

FIG. 1 illustrates a process flow 100 for mounting alignment parts 115 to photonic dies 130 using a mounting FAU 110, according to one embodiment. As shown in the upper left corner of FIG. 1, a FAU gripping tool 101 uses a gripper 105 to hold a mounting FAU 110. The gripping tool 101 can move the mounting FAU 110 (either autonomously using robotic vision or by the aid of a human operator) over a pair of alignment parts 115. In this example, the alignment parts 115 include pins that mate with respective apertures disposed on the sides of the mounting FAU 110. That is, by moving the FAU 110 down, the pins of the alignment parts 115 are inserted into the apertures in the FAU 110.

The gripping tool 101 can then lift up the FAU 110, and due to a sufficiently tight tolerance between the diameters of the apertures in the FAU 110 and the diameters of the pins in the alignment parts 115, the alignment parts 115 remain attached to the FAU 110. Stated differently, the tight tolerances create a frictional force that holds the alignment parts 115 in the FAU 110. This is shown by the upper middle image in FIG. 1.

In this embodiment, the alignment parts 115 are arranged on a part holder 120. The part holder 120 can be a gel-pack provided by the manufacture of the alignment parts 115. The alignment parts 115 can be attached to the gel-pack to have a rough alignment with the apertures in the mounting FAU 110 so that the gripping tool 101 can move the FAU 110 down in order to capture a pair of the alignment parts 115.

After mating the FAU 110 with two alignment parts 115, the upper right image in FIG. 1 illustrates actively aligning the FAU 110 to a photonic die 130 in a wafer 125 containing multiple photonic dies 130. For clarity, the gripping tool 101 is not shown in this image, but it can be used to move the mounting FAU 110 in a plane parallel to the top surface of the photonic die 130 until optical fibers in the FAU 110 are aligned with, for example, a grating coupler in the photonic die 130.

In active alignment techniques, device alignment is based on the maximization of coupled power. In this case, an optical signal may be transmitted by the FAU 110 into the photonic die 130 and can be measured (or vice versa). The FAU 110 can be moved until the measured power of the optical signal is at a maximum.

Moreover, epoxy or some other adhesive can be applied to a portion of the photonic die 130 where the alignment parts 115 are placed. Then, after active alignment is performed, the epoxy can be cured so that the alignment parts 115 are held fixedly in place. For example, the alignment parts 115 may be made of a transparent material, such as glass that is transparent to UV light which can pass through the alignment parts 115 to cure the epoxy.

In contrast, there may not be any epoxy placed underneath the mounting FAU 110. That way, the mounting FAU 110 is not attached to the photonic die 130. As shown in the lower right image of FIG. 1, the FAU 110 is lifted off the photonic die 130, leaving the alignment parts 115 still attached to the die 130. Because the alignment parts 115 are attached (e.g., using cured epoxy) to the die 130, this overcomes the frictional force between the FAU 110 and the alignment parts 115 so that the parts 115 remain on the photonic die 130.

When there is a gap between the optical fiber ends in the FAU 110 and the grating coupler in the photonic die 130, an index-matching epoxy is often used. However, since there may be no epoxy used when actively aligning the mounting FAU 110 to the die 130, but there may be an air gap, offset precompensation can be used to account for the shift between the air gap to an index matched gap. Put differently, active alignment performed using the mounting FAU 110 can be performed dry without index matching, which means there may be slight offset between active alignment and final connector alignment. This offset can be pre-compensated for. However, in other embodiments, there may not be a gap between the optical fiber ends in the FAU 110 and the grating coupler, which means offset precompensation may not be needed.

The steps of retrieving a pair of alignment parts 115 using the mounting FAU 110, aligning the FAU 110 and the parts 115 to a photonic die 130, and fixedly attaching the alignment parts 115 to the die 130 can be repeated until all the photonic dies 130 in a wafer 125 have a pair of alignment parts 115.

While FIG. 1 illustrates that the mounting FAU 110 is gripped by the tool 101, this is just one example. Because the mounting FAU 110 is used multiple times (potentially hundreds of times or more) to align pairs of the alignment parts 115 to respective dies 130, the mounting FAU 110 may be attached to an alignment tool using different techniques such as being strapped, tied, or glued to the tool.

The alignment parts 115 are now aligned on the photonic die 130 in such a way that when a new FAU is attached to the parts 115, it will be aligned with the grating coupler (or other waveguide optical interface) in the photonic die 130. This is shown in the lower left image in FIG. 1 where a final product FAU 140 (one example being a customer's FAU) is attached to the alignment parts 115. The final product FAU 140 can have a different form factor than the mounting FAU 110. So long as the final product FAU 140 includes apertures that are compatible with the pins in the alignment parts 115, the final product FAU 140 can be mounted on the alignment parts 115 which passively aligns the FAU 140 to the grating coupler in the photonic die 130. Unlike active alignment, passive alignment can be performed without using test optical signals and does not use special alignment tools. Thus, a manufacturer can mount the alignment parts onto the photonic dies, separate the dies, and send them to different customers who can then mount their own custom (or different types of) FAUs onto the alignment parts 115 using passive alignment. Alternatively, the manufacturer may receive customer orders specifying which type of FAU is to be mounted on the dies 130, and mount the final product FAUs 140 before shipping the optical systems to the customer. In this manner, the type of the mounting FAU 110 can be different from the type of the final product FAU 140 that is mounted on the photonic die 130 and is used during operation.

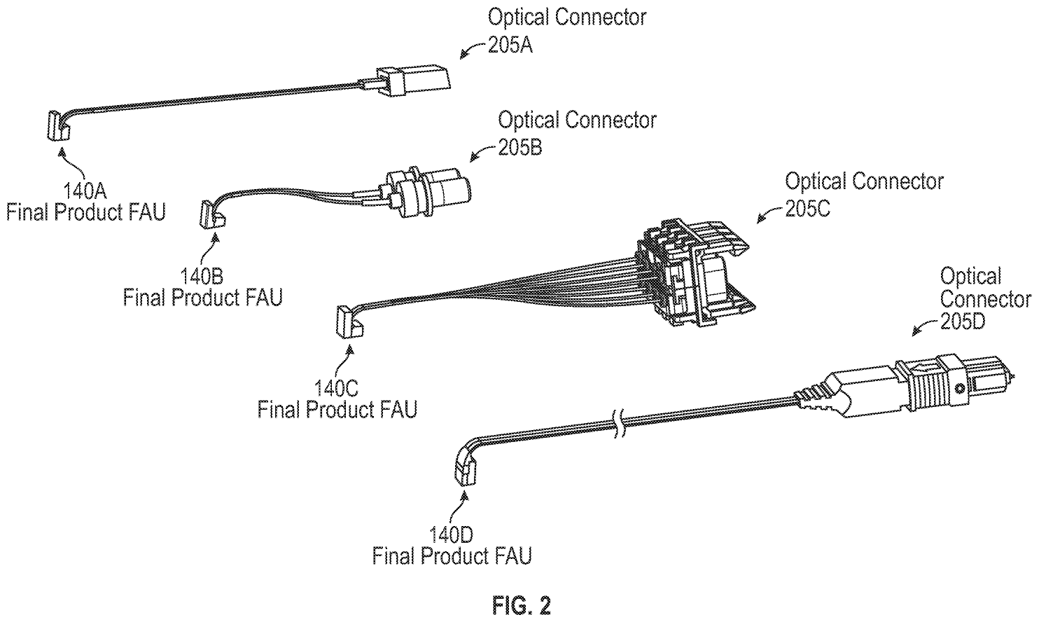

FIG. 2 illustrates different types of optical connectors 205 with different FAUs 140, according to one embodiment. For example, different customers may desire to couple different types of optical connectors 205 (which can have different FAUs 140) to the photonic dies (e.g., the photonic dies 130 in FIG. 1). FIG. 1 illustrates a process where a mounting FAU is used to mount alignment parts to the photonic die. These alignment parts can then be used to attach any of the different FAUs 140 to the photonic die. For example, the different FAUs 140 can be connected to the alignment parts so long as they include apertures that can mate with the pins in the alignment parts. The rest of the form factor the FAUs 140 can be different from the mounting FAU.

Thus, a customer is free to use different types of FAUs 140 and optical connectors 205 so long as these FAUs 140 are compatible with the alignment parts. Stated oppositely, the alignment parts can be used to mate a variety of different FAUs 140 and optical connectors 205 to the photonic die. This can be performed either by the manufacturer (when fulfilling a customer's order), or by the customer. In either case, the final product FAUs 140 can be mated to the alignment parts and aligned with an optical interface in the photonic die using passive alignment.

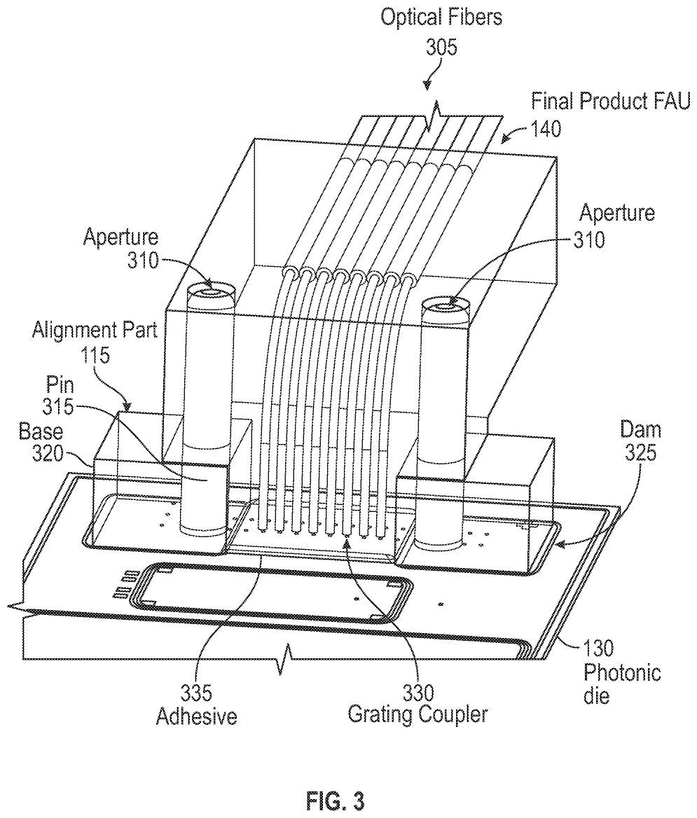

FIG. 3 illustrates attaching an FAU 140 to alignment parts 115 that have previously been attached to a photonic die 130, according to one embodiment. As shown, optical fibers 305 are held by the FAU 140. The ends of the optical fibers 305 can be curved until they reach a side of the FAU 140 that faces an optical interface of the photonic die 130 (e.g., a grating coupler 330). While FIG. 3 illustrates bending the optical fibers 305, in other embodiments, the optical fibers 305 may not bend when extending through the FAU.

The FAU 140 also includes two apertures 310 that are arranged to mate with pins 315 in the alignment parts 115. Put differently, the pitch between the two apertures 310 and the pins 315 is roughly the same. The pitch between the two pins 315 is set by the mounting FAU used to attach the alignment parts 115 to the photonic die 130 as shown in FIG. 1.

Mating the apertures 310 to the pins 315 passively aligns the ends of the optical fibers 305 in the FAU 140 to the grating coupler 330. That is, the pins 315 establish an X-Y location of the optical fibers 305 as well as the appropriate rotation of the FAU 140 so that the optical fibers 305 align with the grating coupler 330. Further, a base 320 of the alignment part 115 can establish a gap between the bottom surface of FAU 140 that includes the ends of the fibers 305 and the grating coupler 330 (e.g., the top surface of the photonic die 130). That is, when the apertures 310 of the FAU 140 are aligned with the pins 315, the FAU 140 can be pressed down until a surface of the FAU 140 contacts a top surface of the base 320. This prevents the FAU 140 from moving any further towards the photonic die 130. The height of the base 320 can be set so that the FAU 140 contacts the base 320 when a desired gap is achieved between the ends of the optical fibers 305 and the grating coupler 330. A gap between the FAU 140 and the grating coupler 330 may be desirable since pressing the FAU 140 on the grating coupler 330 may negatively affect the function or performance of the grating coupler 330.

In this embodiment, an adhesive 335 is disposed between the grating coupler 330 and the FAU 140. In one embodiment, this adhesive 335 fills the gap between the grating coupler 330 and the ends of the optical fibers 305.

In one embodiment, the adhesive 335 is an epoxy that is placed in the region of the grating coupler 330 before the FAU 140 is mounted on the photonic die 130. The epoxy can then be cured (due to the FAU 140 being made from a transparent material) to fixedly attach the FAU 140 to the photonic die 130. Further, the epoxy can be index matched to compensate for the gap between the ends of the optical fibers 305 and the grating coupler 330. That is, the epoxy can be used for permanently bonding the FAU 140 to the photonic die 130 (i.e., the FAU 140 is non-removeable), as well as providing index matching between its optical fiber end face and the die 130. Depending on UV transmissivity of the FAU material, low-heat or self-curing epoxy can be used.

However, in another embodiment, it may be desirable to make the FAU 140 removable in case it becomes damaged, which is especially advantageous for CPO. Rather than using a cured epoxy, the adhesive 335 may be a tacky material that may provide some force to hold the FAU 140 on the die 130 but still permits the FAU 140 to be removed without damaging the die 130 or the alignment parts 115. This tacky adhesive 335 can also be index matched to compensate for the gap. For example, a removable gel adhesive can be used for index matching and for protecting the optical interface against contaminants in the environment. The gel can be in a liquid form for dispensing and then cured in position, or it can be pre-formed and applied to the interface before mating the FAU 140 with the alignment parts 115. New adhesive 335 can be applied when an old FAU is being replaced, making this a removable FAU solution.

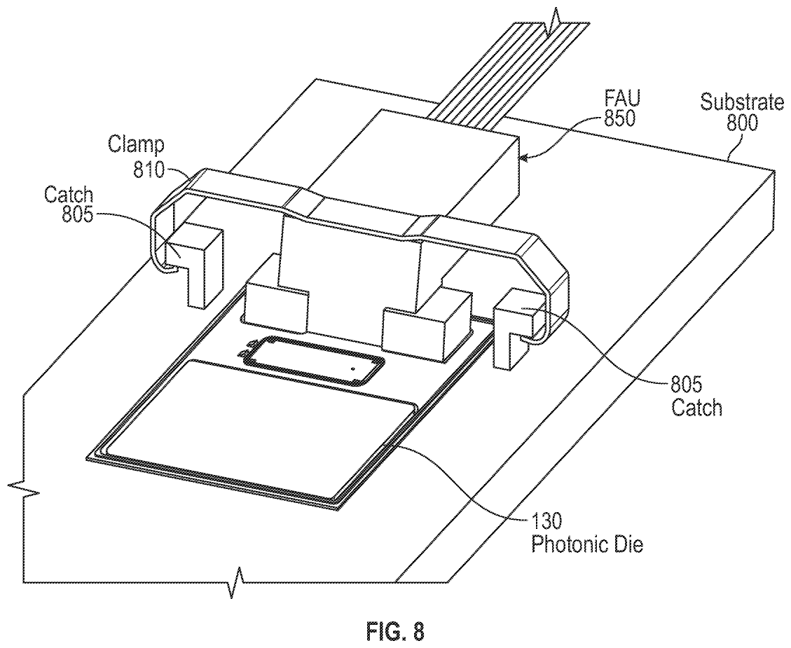

Further, if the tacky adhesive 335 does not provide enough structural support, the FAU 140 can also be attached to the photonic die 130 using a clamp, which is discussed in more detail in FIG. 8.

FIG. 3 also illustrates dams 325 around the bases 320 of the alignment parts 115. The dams 325 can prevent epoxy from leaking out from under the bases 320 and into other parts of the photonic die 130 (e.g., the grating coupler 330) when the alignment parts 115 are being attached to the die 130 as shown in FIG. 1. For example, before using the mounting FAU in FIG. 1 to attach the alignment parts 115 to the die 130, epoxy can be applied within the dams 325. The alignment parts 115 can then be placed on the die 130 and moved around in the area defined by the dams 325 during active alignment of the mounting FAU. Once aligned, the epoxy under the alignment parts 115 can be cured (since the alignment parts 115 can be transparent to UV light) to fixedly attach the alignment parts 115 to the photonic die 130.

In other embodiments, there may also be a dam around the grating coupler 330 to prevent the adhesive 335 from leaking out to other parts of the photonic die 130.

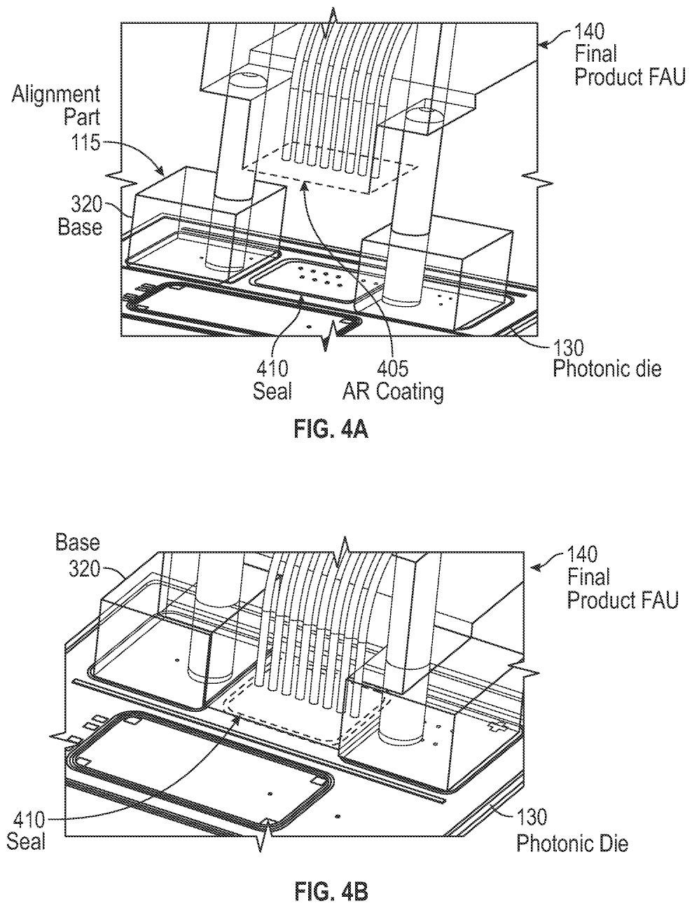

FIGS. 4A and 4B illustrate attaching an FAU 140 to alignment parts 115 that have previously been attached to a photonic die 130, according to one embodiment. In this example, an anti-reflective (AR) coating 405 is applied to an endface of the FAU 140 to allow dry connection to the die. This allows the FAU 140 to become a replaceable unit.

A seal ring 410 is disposed around a periphery of the grating coupler. The seal ring 410 can be made from soft or pliable removable adhesive to prevent contaminants from getting into the optical path. The material of the seal ring 410 does not need to be optically clear which allows a wide range of material selection. The seal ring 410 can also be removed and replaced when the FAU 140 is replaced.

FIG. 4B illustrates mating the FAU 140 with the pins of the alignment parts 115 and sliding the FAU 140 down until its endface contacts the seal ring 410, thereby creating a seal for the optical paths between the optical fibers in the FAU 140 and the grating coupler in the photonic die 130. That is, the seal ring 410 extends around the periphery of both the ends of the optical fibers and the grating coupler.

In this embodiment, the mounting FAU alignment performed in FIG. 1 is the same as the final product FAU 140 alignment in FIG. 4A and does not need offset pre-compensation.

In one embodiment, the seal ring 410 and the mating between the apertures in the FAU 140 and the pins of the alignment parts 115 may not create sufficient structural force to hold the FAU 140 on the photonic die 130. In that case, a clamping mechanism can be added to secure the connection.

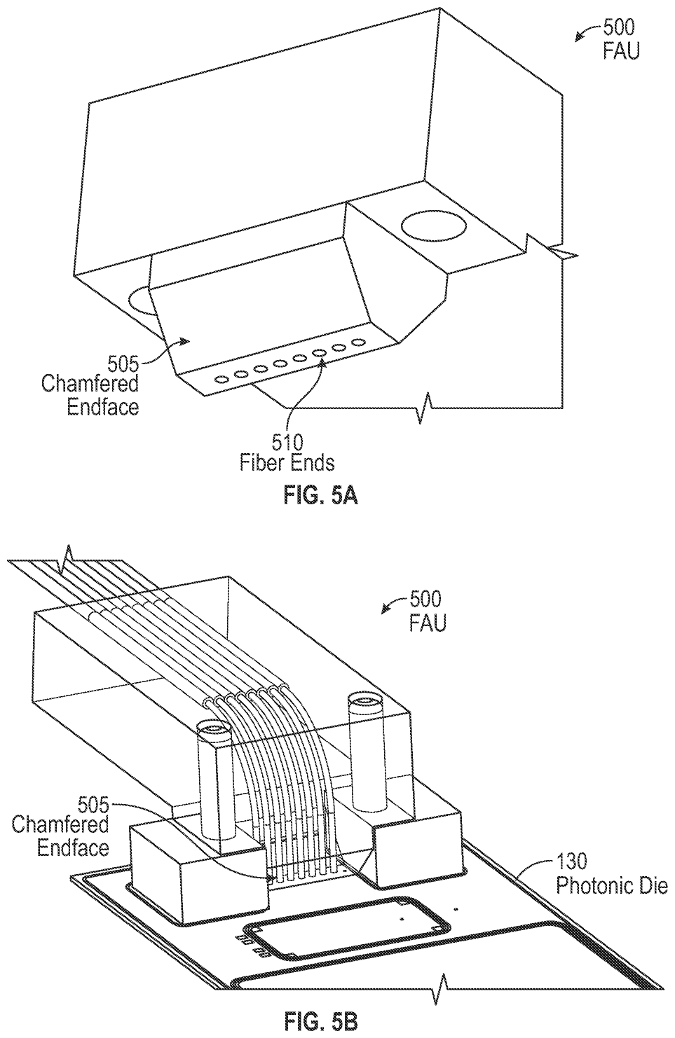

FIGS. 5A and 5B illustrate attaching an FAU 500 to alignment parts that have previously been attached to a photonic die, according to one embodiment. In this example, the endface of the FAU 500 is brought into contact with the portion of the die 130 containing the optical interface (e.g., the grating coupler). Physical contact between the ends 510 of the fibers in the FAU 500 to the die 130 can be made using this approach and is a removable FAU solution.

The fiber ends 510 can slightly protrude from the FAU end face to allow physical contact with the top surface of the die 130. Moreover, the FAU end face can be chamfered to form a chamfered endface 505 to reduce planarity tolerance to allow fiber endface to make physical contact with the die 130. That is, by adding a chamfer, it is less likely that the endface of the FAU 500 will contact the top surface of the die 130 before the fiber ends 510 contact the top surface of the die 130. In contrast, the adhesive 335 in FIG. 3 establishes a bond line that is tolerant of some amount of tilting. However, FIG. 5B does not have an adhesive to provide this tolerance, but the chamfered endface 505 provides some tolerance to tilting of the FAU 500.

In this embodiment, the mounting FAU alignment illustrated in FIG. 1 is performed with a defined bond line height and the final connection between the FAU 500 and the die 130 has a zero bond line height, therefore offset pre-compensation may not be needed. However, in other examples since alignment has some bondline height and final FAU 500 has zero bondline height there may be some offset pre-compensation if the fiber is not angle polished.

In one embodiment, the mating between the apertures in the FAU 500 and the pins of the alignment parts 115 may not create sufficient structural force to hold the FAU 500 on the photonic die 130. In that case, a clamping mechanism can be added to secure the connection and to provide physical connection engagement force.

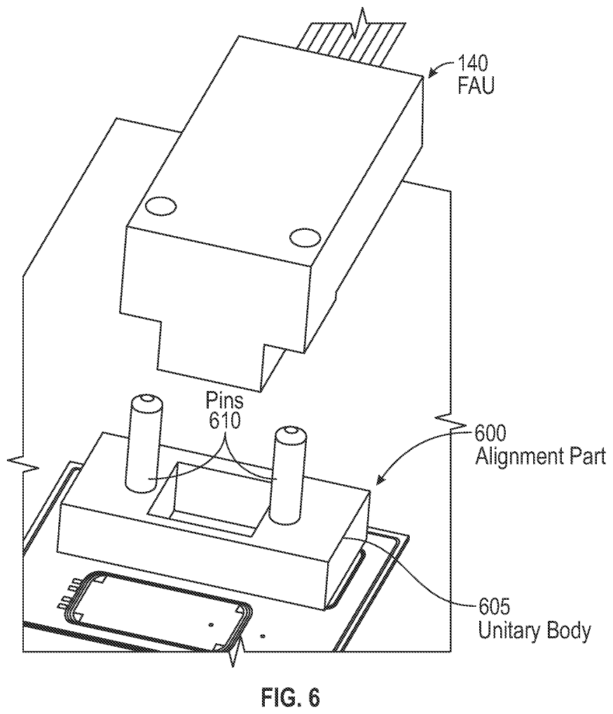

FIG. 6 illustrates an alignment part 600 with a unitary body 605 that holds two pins 610, according to one embodiment. This embodiment shows alignment pin pairs installed in a single-piece pin-body 605 (or base). The single-piece pin-body design has better structural integrity compared to using separate alignment parts 115 as shown in the previous figures, and eliminates pin-rotation. Further, the body 605 establishes the pitch between the pins 610.

One disadvantage of using two pins on separate alignment parts as discussed above is that the pins should have a similar angle. This alignment issue can be resolved by using the alignment part 600 when the body 605 ensures the pins 610 have the same angle due to the rigidity of the body 605. However, one disadvantage of the alignment part 600 is it may have a larger footprint than using two separate alignment parts. Also, the pitch between the pins 610 is defined by the body 605 rather than the mounting FAU, which means the manufacturing of the part 600 should be precise. Accurate pitch distance between the alignment pins 610 can be achieved using techniques such as selective laser assisted chemical etching.

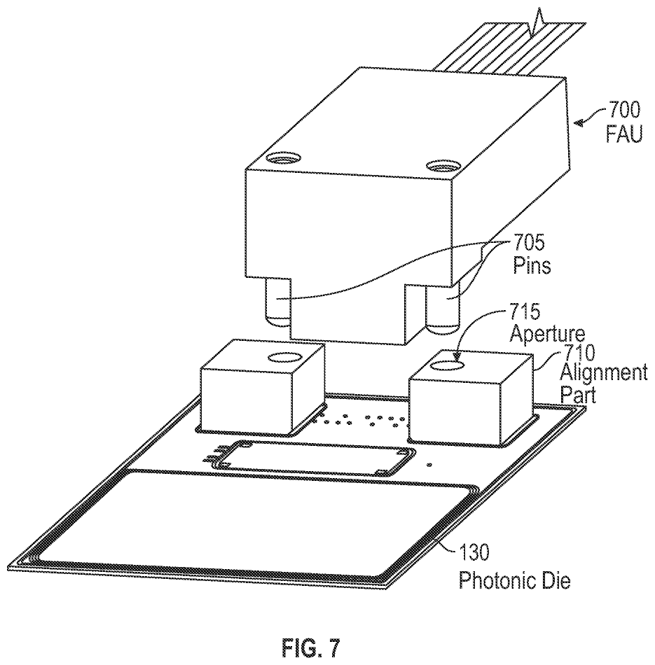

FIG. 7 illustrates an alignment part 710 with an aperture 715, according to one embodiment. That is, instead of the alignment parts 710 having pins as shown in the previous figures, in this embodiment, the alignment parts 710 include apertures 715 (e.g., formed in a respective base). Moreover, the FAU 700 includes two pins 705, rather than having apertures like in the FAUs discussed above. The two pins 705 can mate with the apertures 715 when mounting the alignment parts 710 on the photonic die as discussed in FIG. 1, and when mounting a final product FAU to the photonic die 130 as discussed in FIGS. 2-5.

Advantageously, apertures in the mounting FAU may wear out faster than pins. That is, when the mounting FAU illustrated in FIG. 1 has apertures, these may wear out faster (e.g., by expanding) than if the mounting FAU had pins 705 as shown in FIG. 7.

Moreover, in other embodiments, the FAU 700 may include one aperture and one pin, while one alignment part could have an aperture 715 and another could have a pin. Thus, the FAUs and alignment parts can have a mixture of pins and apertures.

In addition, rather than having two separate alignment parts 710, the apertures 715 could be formed in a unitary body like in FIG. 6. This can have the same advantages and disadvantages as discussed in FIG. 6.

FIG. 8 illustrates a clamp 810 for fastening a removable FAU 850 to a photonic die 130, according to one embodiment. As mentioned above, if cured epoxy is not used to attach the FAU to the die 130 in order to make the FAU removable, there may not be sufficient structural support provided by mating the FAU to the alignment part or parts. As such, the clamp 810 can be added to the optical system to provide additional support.

As shown, the clamp 810 contacts a top surface of the FAU 850 and fastens to catches 805 formed on a substrate 800 on which the photonic die 130 is mounted. When attached to the catches 805, the clamp 810 applies a downward force on the top of the FAU 850 to hold it on the photonic die 130. When replacing the FAU 850, the clamp 810 can be removed first and then replaced after a new FAU has been mounted on the die 130.

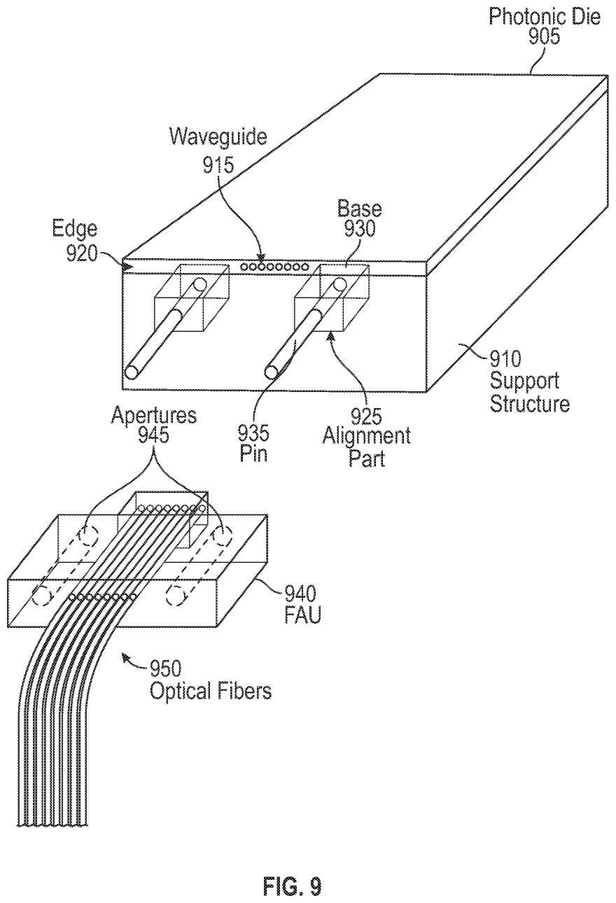

FIG. 9 illustrates attaching an FAU 940 to alignment parts 925 disposed on an edge 920 of a photonic die 905, according to one embodiment. In this example, the photonic die 905 includes waveguide 915 that are exposed at the edge 920 (or side) of the die 905). Instead of using a grating coupler disposed at the top of the photonic die 905, the edge 920 provides an optical interface where the FAU 940 can be butt-coupled to the photonic die 905.

In order to align the waveguides 915 in the photonic die 905 to optical fibers 950 in the FAU 940, two alignment parts 925 have been placed on the edge 920 of the photonic die 905. Because the thickness of the photonic die 905 may not be sufficient to support the alignment parts 925, the die 905 is mounted on a support structure 910 (e.g., a substrate or base) that provides sufficient thickness at its edge to support the alignment parts 925.

In one embodiment, the alignment parts 925 are mounted to the edge 920 of the photonic die 905 using a similar process as illustrated in FIG. 1. That is, a mounting FAU can be actively alignment to the waveguide 915, and in doing so, establishes the alignment of the parts 925. The parts 925 can then be fixedly attached to the edge 920 (e.g., using epoxy). Later, the FAU 940 (e.g., a final product FAU) can be passively aligned to the waveguide 915 by mating apertures 945 in the FAU 940 to pins 935 that are supported by bases 930 of the alignment parts 925.

Thus, FIG. 9 illustrates that the processes and techniques discussed above can also be applied to edge coupled photonic systems. In addition, while FIG. 9 illustrates using a pair of alignment parts 925, in another embodiment, a single alignment part could be used as shown in FIG. 6. Also, instead of using pins 935, the alignment parts (or part) could have apertures while the FAU 940 has pins as shown in FIG. 7.

Moreover, the FAU 940 can be permanently attached to the edge 920 of the die 905 or could be a removable part. If removable, the FAU 940 may be attached to the die 905 using a clamp.

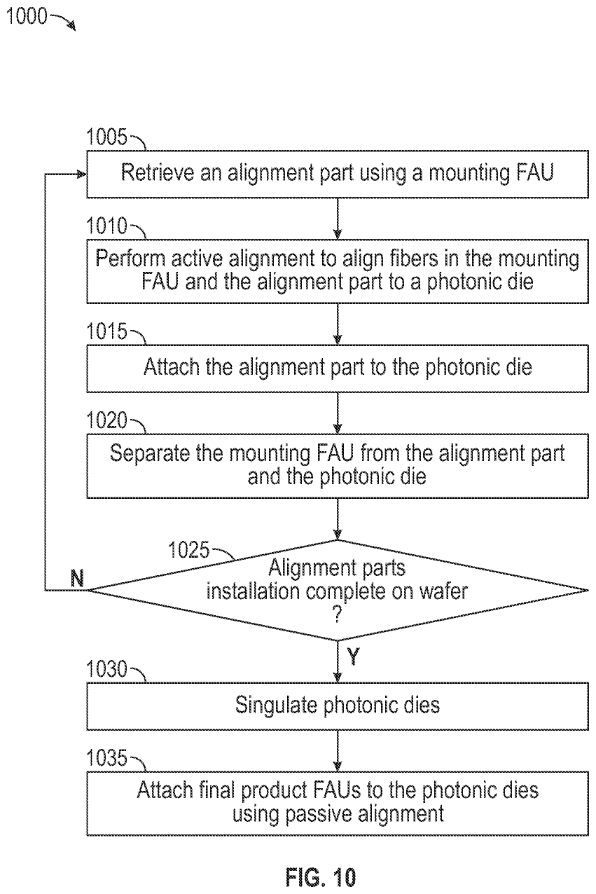

FIG. 10 is a flowchart of a method 1000 for attaching alignment parts to a photonic die, according to one embodiment. At block 1005, a mounting FAU retrieves an alignment part. The mounting FAU can include an aperture that mates with a pin of the alignment part, or a pin that mates with an aperture in the alignment part, or some other suitable mating system.

Further, the mounting FAU may retrieve two (or more) alignment parts at block 1005 as shown in FIG. 1 or may retrieve a single alignment part, such as the alignment part shown in FIG. 6.

At block 1010, the mounting FAU performs active alignment to align optical fibers in the mounting FAU and the alignment part to a photonic die. In one embodiment, the active alignment is performed between the FAU and a grating coupler in the top surface of the photonic chip. As the FAU is moved during active alignment, so are the alignment parts. Alternatively, the active alignment is performed between the FAU and waveguides at an edge of the photonic chip as shown in FIG. 9.

At block 1015, the alignment part (or parts) is attached to the photonic die. This may include using UV light or heat to cure epoxy that bonds the attachment part to the photonic die.

At block 1020, the mounting FAU is separated from the alignment part and the photonic die. That is, the mounting FAU is detached from the alignment part (e.g., lifted off the photonic die). However, the alignment part remains attached to the photonic die.

At block 1025, it is determined whether the alignment parts installation is complete on a wafer. That is, the method 1000 is a wafer-level process that can attach at least one alignment part to each photonic die in a wafer using the same mounting FAU. However, in other embodiments, the method may be used to attach alignment parts to photonic dies that have already been diced from the wafer.

Assuming there are photonic dies on the wafer that do not yet have alignment parts, the method 1000 returns to block 1005 where the mounting FAU retrieves another alignment part and the method 1000 repeats.

However, assuming alignment parts have been attached to all the photonic dies on the wafer, the method 1000 proceeds to block 1030 where the photonic dies are singulated, e.g., the wafer is diced.

At block 1035, final product FAUs are attached to the photonic dies using passive alignment, which may not require any special alignment tools. Moreover, the final product FAUs may have a different form factor than the mounting FAU, so long as they have the alignment features (e.g., apertures or pins) that are compatible with the alignment parts that were attached to the photonic dies at block 1015.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved.

In view of the foregoing, the scope of the present disclosure is determined by the claims that follow.

We claim:

1. A method, comprising:
retrieving an alignment part using a mounting fiber array unit (FAU);
performing active alignment to align fibers in the mounting FAU and the alignment part to a photonic die;
after aligning the mounting FAU to the photonic die, attaching the alignment part to the photonic die; and
after attaching the alignment part, separating the mounting FAU from the alignment part and the photonic die.

2. The method of claim 1, further comprising:
retrieving a different alignment part using the mounting FAU;
performing active alignment to align the fibers in the mounting FAU and the different alignment part to a different photonic die that is part of a same wafer as the photonic die;
after aligning the mounting FAU to the different photonic die, attaching the different alignment part to the different photonic die; and
after attaching the different alignment part, separating the mounting FAU from the different alignment part and the different photonic die.

3. The method of claim 1, further comprising:
retrieving a different alignment part using the mounting FAU at a same time as retrieving the alignment part;
aligning the different alignment part to the photonic die at a same time as aligning the alignment part to the photonic die; and
attaching the different alignment part to the photonic die, wherein the mounting FAU is separated from the photonic die after both the alignment part and the different alignment part are attached to the photonic die.

4. The method of claim 3, wherein the alignment part and the different alignment part include respective pins that mate with respective apertures in the mounting FAU.

5. The method of claim 3, wherein the alignment part and the different alignment part include respective apertures that mate with respective pins in the mounting FAU.

6. The method of claim 1, wherein the alignment part comprises a unitary body that comprises at least two alignment features that mate with at least two alignment features in the mounting FAU.

7. The method of claim 1, further comprising:
mating a different FAU to the alignment part after the alignment part has been attached to the photonic die, wherein mating the different FAU to the alignment part passively aligns fibers in the different FAU to waveguides in the photonic die.

8. The method of claim 7, wherein the different FAU is removeable from the photonic die and the alignment part.

9. The method of claim 8, wherein the different FAU is attached to the photonic die using a removable gel adhesive.

10. The method of claim 8, wherein the different FAU comprises an anti-reflective (AR) coating disposed at ends of the fibers, wherein the photonic die comprises a seal ring disposed around a periphery of the fibers.

11. The method of claim 8, further comprising:
attaching the different FAU to the photonic die using a clamp.

12. The method of claim 7, wherein the different FAU is non-removeable from the photonic die and the alignment part.

13. The method of claim 7, wherein the different FAU is chamfered at an endface that faces the photonic die.

14. The method of claim 1, wherein the alignment part is attached to a top surface of the photonic die.

15. The method of claim 1, wherein the alignment part is attached to an edge of the photonic die.

16. An optical system, comprising:
a photonic die comprising waveguides;
an alignment part that is bonded to a surface of the photonic die using an adhesive; and
a FAU mated with the alignment part, wherein the mating between the FAU and the alignment part aligns optical fibers in the FAU to the waveguides in the photonic die.

17. The optical system of claim 16, further comprising:
a different alignment part bonded to the surface of the photonic die using the adhesive, wherein the FAU mates with both the alignment part and the different alignment part to align the optical fibers in the FAU to the waveguides in the photonic die.

18. The optical system of claim 17, wherein the alignment part and the different alignment part each comprise at least one of a respective pin or a respective aperture that mates with apertures or pins in the FAU.

19. The optical system of claim 16, wherein the alignment part is a unitary part that comprises at least two alignment features that mate with at least two alignment features in the FAU.

20. The optical system of claim 16, wherein the FAU is removeable from the photonic die and the alignment part.
